(19) United States
(12) Patent Application Publication
(10) Pub. No.: US 2007/0278753 A1
(43) Pub. Date: Dec. 6, 2007

(54) SNOWBOARD

(76) Inventor: Robert A. Candler, Truckee, CA (US)

Correspondence Address: SIERRA PATENT GROUP, LTD., 1657 Hwy 395, Suite 202, Minden, NV, 89423, US

(21) Appl. No.: 11/422,490

(22) Filed: Jun. 6, 2006

(51) Int. Cl. B62B 13/00

(52) U.S. Cl. 280/14.22

(57) ABSTRACT

A snowboard having a contoured bottom surface wherein a raised profile near the center of the bottom surface defines a pair of parallel, longitudinal channels through which snow is directed toward the tail end of the snowboard. Inboard from the tail end, aligned with at least one of the channels, an aperture is located that allows snow to be ejected vertically, forming a plume or rooster tail of snow as the rider passes over the snow.

### FIELD

The present invention relates to snowboarding. Specifically, the present invention relates to a snowboard having a contoured bottom surface.

### BACKGROUND OF THE INVENTION

Snowboarding remains a popular winter sport in many areas that have hills or mountains that are suitable for snow skiing. Unlike skis, snowboards require the rider to strap both feet to a single snow board and ride it in a stance similar to how a skateboard is ridden. Indeed, both snowboarding and skateboarding incorporate similar rider movements to control direction and speed. Like a skateboard, a snowboard has a length defined by a nose end at the front end of the snowboard and a tail end at the rear end of the snowboard. A snowboard's width is defined by two running edges that are substantially parallel to each other and run the length of the snowboard.

Examples of prior art snowboards include U.S. Pat. No. 3,782,745, issued to Stovekin; U.S. Pat. No. 4,974,868, issued to Morris; U.S. Pat. No. 5,580,078 issued to Vance; U.S. Pat. No. Des. 308, 996 to Katz, and U.S. Pat. No. Des. 346, 194 to Ferris.

The Stovekin snowboard sought to improve steering and ride characteristics by adding steering skegs and shock absorption devices to a snowboard. The Morris snowboard includes transverse channels and longitudinal grooves formed by longitudinal, downwardly-extending edges to facilitate movement through the snow. The Vance snowboard includes running edges secured to the lower edges of the snowboard to improve handling characteristics of the board. The Katz snowboard includes several shapes formed or cut in the upper surface of the snowboard for ornamental reasons. The Ferris snowboard, provides a two piece capped board with a fin-shaped tail.

Typically, snowboards are manufactured from laminated materials, which subjects snowboards to delamination problems and significant manufacturing cost. Snowboards are subject to punishing conditions of being in constant contact with snow and ice while bearing the weight of a rider. Aggressive riders demand snowboards that can withstand riders' jumping or “catching air” with the snowboard, which results in significant shock to the snowboard when landing on hardpacked snow or ice. Another more common impact to a snowboard comes from colliding with obstacles such as rocks or trees, or other collisions that occur during transport. Running edges bear the brunt of these collisions, which can damage the integrity of the snowboard. To combat the wear on running edges, some snowboards incorporate permanently-secured running edge guards attached to the running edges of the snowboard. They are typically so rigid and permanently affixed to the snowboard that they are an integral part of the snowboard, and define control and handling characteristics for the snowboard. Unfortunately, it is very difficult to remove and replace damaged edge guards on a snowboard because they are often bonded to the snowboard body through epoxy. Delamination problems and replacement of edge guards require the average rider to pay a professional shop to repair the snowboard or change the edge guards, which is cost-prohibitive. Thus, there is a need for a more simple material to be used in a snowboard body as well as a need for edge guards that are easier to maintain.

Another shortcoming of prior art snowboards is that snow is not significantly diverted by contours on the bottom surface of the board or any other part of the snowboard, whether for speed, handling or simple aesthetics. In the sport of offroad motorcycle riding, for example, riders enjoy generating a plume of dirt that is ejected vertically from the back tire, often referred to as a “rooster tail.” A similar plume can be seen in the operation of speed boats and jet skis, which can create a plume of water vertically from the behind the stern of the boat or from the back end of a jet ski.

Finally, current snowboards are opaque. The laminated construction is usually fiberglass, plastic, and/or metal, and thus the rider cannot see the surface beneath the snowboard.

### SUMMARY OF THE INVENTION

The present invention overcomes the shortcomings described above by providing a snowboard having a contoured bottom surface wherein a raised profile near the center of the bottom surface defines a pair of parallel, longitudinal channels through which snow is directed toward the tail end of the snowboard. Inboard from the tail end, aligned with at least one of the channels, an aperture is located that allows snow to be ejected vertically, forming a plume or rooster tail of snow as the rider passes over the snow. This vertical ejection of snow also helps keep the tail end of the snowboard in contact with the snow, which reduces chatter and improves handling of the snowboard. The raised profile in the center of the bottom surface also provides rigidity to the snowboard as it is located beneath the area where a rider secures his boots in bindings on the top surface of the snowboard. In the preferred embodiment, the raised profile has a shape that is substantially that of the profile of an hourglass, where a first round, raised area under the forward foot of the rider and the second round, raised area under the rear foot of the rider are connected by a longitudinal raised profile area, such that the raised profile protrudes outward from the bottom surface of the snowboard and makes contact with the snow or ice.

In another aspect of the present invention, the preferred material for construction of the snowboard is transparent polycarbonate, formed in a single, non-laminated shape. This material is also easily recycled. In alternative embodiments, the snowboard is constructed from polymethyl methacrylate. The preferred embodiment of the present invention is thin enough to allow the snowboard body to flex during riding, so that more of the snowboard's bottom surface remains in contact with soft snow, and absorb some shock while riding over hardpacked snow or ice. In the preferred embodiment, the thickness of the snowboard typically varies from about 0.5 inches to about 0.25 inches.

In yet another aspect of the present invention, the snowboard includes edge guards that are easily removed and replaces. By incorporating a channel along the running edge, an edge guard can have an interior shape that is inserted into the channel and secures the edge guard to the running edge. In the preferred embodiment, the leading point of the edge guard is secured also by a removable nose piece that attaches to the nose end of the snowboard, thus protecting the edge guard from forward-point collisions that might tear the edge guard lose from the snowboard.

Many other features and advantages of the present invention will be realized by reading the following detailed description, when considered in conjunction with the accompanying drawings, in which:

### BRIEF DESCRIPTION OF THE DRAWINGS

FIG. 1 is a plan view of the bottom surface of the snowboard of the present invention.

FIG. 2 is an elevation view of the snowboard showing a cross sectional view from the aspect of the nose end of the snowboard.

FIG. 3 is a cross sectional view of the snowboard having exit holes for snow and ice channeled along the bottom of the snowboard.

### DETAILED DESCRIPTION

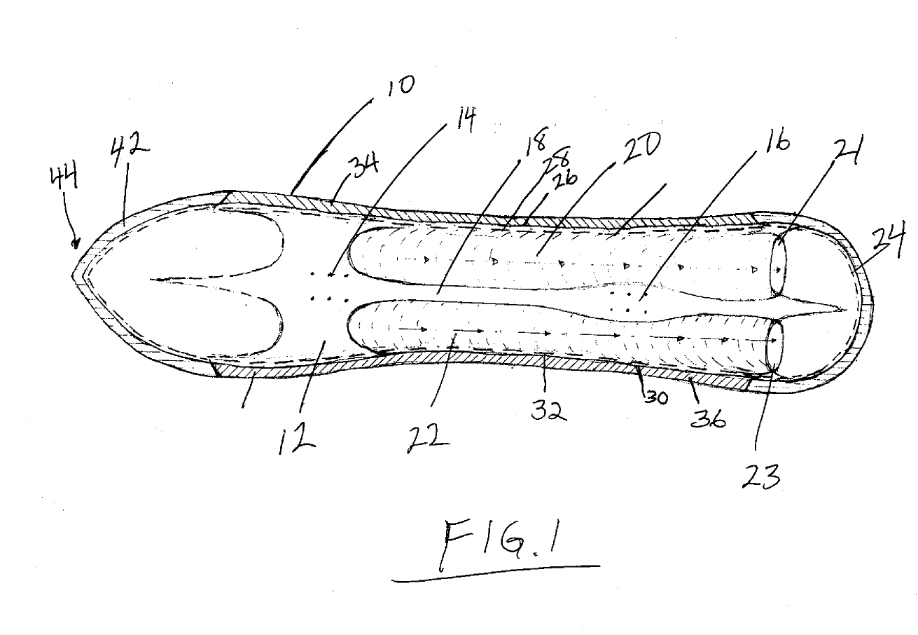

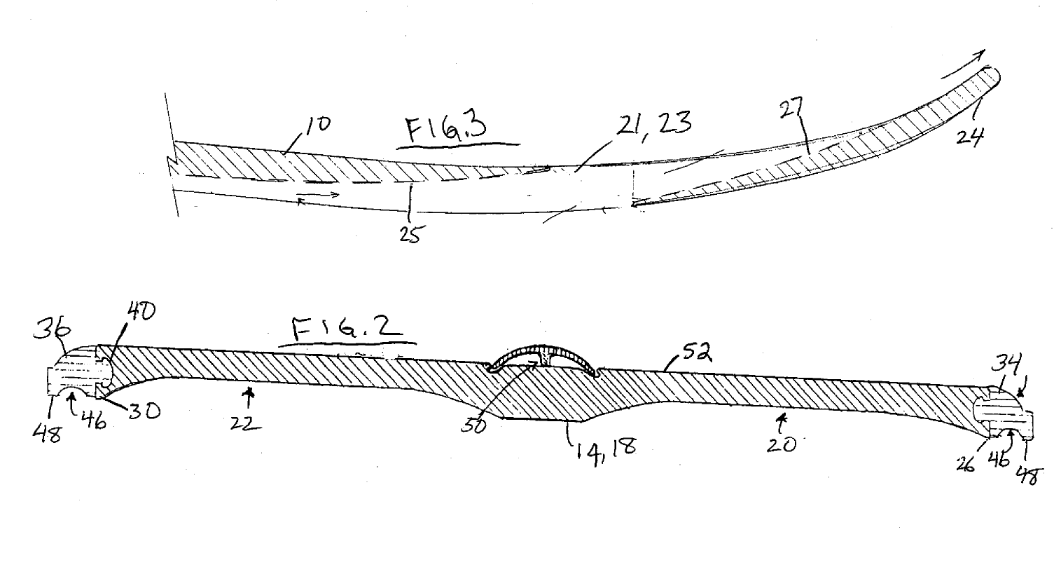

Directing attention to FIG. 1, there is shown bottom surface 12 of snowboard 10 having a plurality of features of the present invention. Bottom surface 12 includes first raised area 14, which in the preferred embodiment is located substantially under the forward boot binding on the top side of snowboard 10. Second raised area 16, in the preferred embodiment, is located substantially under the rear boot binding on the top side of snowboard 10. Connecting raised area 18 joins first raised area 14 to second raised area 16, and forms a divider that separates snow underneath snowboard 10 and guides it through channels 20, 22. In some embodiments, connecting area 18 extends no farther than between first raised area 14 and second raised area 16, as shown in FIG. 1, connecting raised area can extend beyond first raised area 14 and second raised area 16 to form a central rail protruding from bottom surface 12. While in the preferred embodiment, first raised area 14 and second raised area 16 are substantially circular shapes that protrude downward from bottom surface 12 and can be somewhat spherical, they also can be shaped as shown in FIG. 1 to streamline the diversion of snow between and along channels 20, 22. Channels 20, 22 in the preferred embodiment are concave, longitudinal channels formed in bottom surface 12. The side of channel 20 and edge 26 define edge rail 28, and the side of channel 21 and edge 30 define edge rail 32. As shown in FIG. 2, snowboard 10 includes a trimaran design, in which there are three runners or rails supporting snowboard 10, defined by edge rail 28 on one side, the combination of first raised area 14, second raised area 16, and connecting raised area 18 as the central rail, and edge rail 32 on the other side. Snow displaced by these rails is directed through channels 20, 22. While in the preferred embodiment connecting area 18 is disposed between raised areas 14, 16, in an embodiment, connecting area 18 may be utilized in a design without any other raised areas, such as raised areas 14, 16.

In an embodiment, channels 20, 22 include apertures 21, 23, respectively, through which snow passing through channels 20, 22 exit. Directing attention to FIG. 3, apertures 21, 23 are positioned such that snow passes through them, thus reducing the drag or resistance of the portion of bottom surface 12 that is located between apertures 21, 23 and tail end 24. In an embodiment, apertures 21, 23 have forward edge 25 and read edge 27, both of which are oriented at acute angles with respect to the plane defining bottom side 12. When operated at sufficient speed, snow exiting from apertures 21, 23 is ejected upward in a substantially vertical direction with respect to bottom surface 12, creating a plume or rooster tail that is not only aesthetic, but also exerts a downward pressure on tail end 24 of snowboard 10. This is effective to reduce vibration or chatter experienced in the tail end when passing over a hardpacked snow or ice. The plume or rooster tail generated by snowboard 10 is also effective for teaching other riders to maintain a safe distance from snowboard 10. In an embodiment, diverters may be placed over apertures 21, 23 to divert the plumes, such as to a desired degree to left or right, elevational configuration, apart from each other, etc. Connection of diverters to snowboard 10 can incorporate the connection technique of edge guard 34.

Returning to FIG. 2, in an embodiment, edge guard 34 is attached to edge 26 and edge guard 36 is attached to edge 30 to protect snowboard 10 from impacts such as collisions with obstacles and general wear and tear associated with transporting and storing snowboard 10. Edge guards 34, 36 are flexible, extruded pieces of material, such as plastic or rubber, and include a key 38 that feeds into channel 40. Channel 40 is formed in edges 30 and 32 and receives edge guards 34, 36. In an embodiment, edge guards 34, 36 can be made from sufficiently flexible material to allow them to be pressed or hammered into channel 40. Also in an embodiment, removable nose guard 42, also made from plastic, rubber or other durable material, can be secured on nose end 44, and hold edge guards 34, 36, in place. As shown in FIG. 1, edge guards 34, 36 can be shaped to provide channel 46 and edge rail 48. Edge guards having this profile can improve handling and steering characteristics for snowboard 10.

Because snowboard 10 is flexible in the preferred embodiment, additional stiffening of snowboard 10 can be obtained by placing stiffener 50 on top side 52. In the preferred embodiment, stiffener 50 is positioned above the central rail formed by connecting raised area 18 on bottom surface 12. There are several ways contemplated for attaching stiffener 50. In a simple embodiment, stiffener 50 incorporates flat sections that are secured between snowboard 10 and the rider's boot bindings that are attached to top side 52. In a preferred embodiment, stiffener 50 snaps into channels 54 that are formed in top side 52. Stiffener 50 can be offered in a variety of flexibilities, and selected based on snow conditions or simply by rider preference.

While a unitary snowboard has been described and illustrated in its best mode, it is to be understood that many changes can be made to the various embodiments of the invention without departing from the spirit thereof.

What I claim is:

1. A unitary snowboard of the type in which a user binds both of the user's feet to the unitary board in order to ride the snowboard on snow, the unitary snowboard comprising:
a front end and a back end;
a top side and a bottom side disposed between the front end and the back end, the top side attaching to a user's boots, the bottom side contacting snow on which the snowboard rides; and
at least one aperture, the aperture extending from the bottom side through the snowboard to the top side, the aperture angled to eject snow through the snowboard.

2. The unitary snowboard of claim 1, wherein the at least one aperture is located aft of a mounting point for attaching to the user's boots.

3. The unitary snowboard of claim 1, wherein the snowboard is constructed from polymethyl methacrylate.

4. The unitary snowboard of claim 1, wherein the snowboard is constructed from polycarbonate.

5. The unitary snowboard of claim 1 wherein the at least one aperture has a forward side and a rear side, each side disposed at an acute angle to the plane of the adjacent portion of the bottom side of the snowboard body.

6. The unitary snowboard of claim 5 wherein the bottom side also has a concave detent abutting the aperture and extending therefrom toward the back end of the board body.

7. The unitary snowboard of claim 6 wherein the concave detent has two opposing detent edges abutting the bottom side along its axial length, each said detent edge being bowed toward the opposing detent edge of the concave detent, the opposing edges thereby forming an hourglass shape on the bottom side of the board body.

8. The unitary snowboard of claim 1 further comprising a removable nose guard abutting the periphery of the junction of the first end with the top side and the bottom side.

9. The unitary snowboard of claim 1 further comprising at least one removable edge guard, the removable edge guard comprising a keyed profile, the keyed profile securing the removable edge guard against an edge of the snowboard, the edge running from the front end to the back end.

10. The unitary snowboard of claim 9, wherein the removable edge guard comprises a channel and an edge.

11. A unitary snowboard of the type in which a user binds both of the user's feet to the unitary board in order to ride the snowboard on snow, the unitary snowboard comprising:
a front end and a back end;
a top side and a bottom side disposed between the front end and the back end, the top side attaching to a user's boots, the bottom side contacting snow on which the snowboard rides, wherein the bottom side comprises an axis running the length of the snowboard, a raised surface being disposed on the axis.

12. The unitary snowboard of claim 11, further comprising a second raised area, the second raised area having a substantially circular profile.

13. The unitary snowboard of claim 12, further comprising a third raised area, the third raised area having a substantially circular profile.

14. The unitary snowboard of claim 13, wherein the second and third raised areas are disposed such that they are connected to each other by the first raised area.

15. The unitary snowboard of claim 13, wherein the second and third raised areas are substantially beneath a mounting point on the top side of the snowboard.

16. The unitary snowboard of claim 11, further comprising at least one aperture, the aperture extending from the bottom side through the snowboard to the top side, the aperture angled to eject snow through the snowboard.

17. The unitary snowboard of claim 16, wherein the at least one aperture is located aft of a mounting point for attaching to the user's boots.

18. The unitary snowboard of claim 16, further comprising at least a first channel disposed on the bottom side of the snowboard, the channel disposed in lengthwise alignment with the at least one aperture.

19. The unitary snowboard of claim 18, further comprising a second channel disposed on the bottom on the bottom side of the snowboard, the second channel disposed in a parallel relationship with the first channel disposed on the bottom side of the snowboard.

20. The unitary snowboard of claim 11 further comprising a removable nose guard abutting the periphery of the junction of the first end with the top side and the bottom side.

21. The unitary snowboard of claim 11 further comprising at least one removable edge guard, the removable edge guard comprising a keyed profile, the keyed profile securing the removable edge guard against an edge of the snowboard, the edge running from the front end to the back end.

22. The unitary snowboard of claim 21, wherein the removable edge guard comprises a channel and an edge.

23. A unitary snowboard of the type in which a user binds both of the user's feet to the unitary board in order to ride the snowboard on snow, the unitary snowboard comprising:
a front end and a back end;
a top side and a bottom side disposed between the front end and the back end, the top side attaching to a user's boots, the bottom side contacting snow on which the snowboard rides, wherein the bottom side comprises an axis running the length of the snowboard, a raised surface being disposed on the axis, defining a pair of channels in the surface of the bottom side, such that the bottom side is characterized by the presence of a first rail disposed along the lengthwise, central axis, and first and second side rails, said first and second side rails disposed on opposite sides of the first rail.

24. The unitary snowboard of claim 23, further comprising at least one aperture, the aperture extending from the bottom side through the snowboard to the top side, the aperture angled to eject snow through the snowboard.
